(19) United States
(12) Patent Application Publication
(10) Pub. No.: US 2020/0384474 A1
(43) Pub. Date: Dec. 10, 2020

(54) SAMPLE TRACKING CARD

(71) Applicant: Diagnostics for the Real World, LTD., San Jose, CA (US)

(72) Inventor: Philip Stankus, Coldwaltham (GB)

(21) Appl. No.: 16/769,497

(22) PCT Filed: Dec. 20, 2018
(86) PCT No.: PCT/US2018/066888

§ 371 Date: Jun. 3, 2020

(30) Foreign Application Priority Data
Dec. 22, 2017 (GB) 1721725.8

(51) Int. Cl. B01L 3/00; B01L 9/06; G09F 3/04

(52) U.S. Cl. CPC B01L 3/54; B01L 3/5055; B01L 2300/021; B01L 9/06; G09F 3/04; B01L 3/502

(57) ABSTRACT

A sample tracking card for attachment to a container containing a biological sample that has been obtained for testing is described. The card comprises an aperture for receiving an end of a sample collection container and a tab for engaging with another end of the sample collection container to attach the container to the card. The card allows the result of testing on the sample to be reliably matched with the subject without revealing the subject's identity on the container. Kits comprising the card and the container are also described.

This invention relates to a sample tracking card, in particular to a sample tracking card for attachment to a container containing a biological sample that has been obtained for testing, and to kits comprising the card and the container.

When a biological sample is collected from a subject for testing, for example to determine whether the subject is infected with an infectious disease, it is important that the subject's identity is not revealed on the container in which the biological sample has been collected, and that the result of testing on the sample can be reliably matched with the subject once the result has been obtained so that the sample is not confused with samples from other subjects. There is a need, therefore, to provide a convenient way of tracking samples obtained from subjects such that the subject's anonymity is preserved and the result of testing on the sample can reliably be matched to the subject.

According to the invention there is provided a sample tracking card, which comprises an aperture for receiving an end of a sample collection container and a tab for engaging with another end of the sample collection container to attach the container to the card.

The sample collection container is held in place in the aperture by the tab. Optionally the tab is positioned for engaging with the end of the sample container after the sample container is received in the aperture.

Optionally the aperture is defined within a hinged flap of the card. The hinged flap is advantageous because it allows the card to be stored flat when not attached to a sample collection container.

Optionally the hinged flap is defined by cuts through the card. Optionally the flap is hinged to the card along a fold line in the card. Optionally the fold line is defined by scoring of the card or by perforations through the card along the fold line.

Optionally the tab engages with a recess in a lid of the container.

Optionally the tab is defined by a cut-out from the card. Optionally, the cut-out also defines an edge of the hinged flap. Advantageously, the edge of the hinged flap defined by the cut-out is opposite a hinged edge of the flap, thereby minimising the number of cuts required to be made to the card to provide the hinged flap and the tab.

The sample collection container may comprise a tube having a narrower closed end for engaging with the aperture in the card, and a wider open end having a removable cap for sealing the tube. The aperture may be sufficiently large to receive the narrower end of the container, but not large enough to allow the container to pass through the card, for example because of stepping in an outer side wall of the container.

Optionally the container comprises a side wall that extends gradually from the narrower end of the container to the wider open end, or is stepped outwards from the narrower end to the wider end.

The cap may comprise a recess for engaging with the tab. The cap may be a screw-cap or a push-fit cap. The cap may be attached to a retaining ring, which is retained by a collar of wider diameter than an internal diameter of the retaining ring at the open end of the container.

Optionally the container is a tube of circular cross-section, and the aperture is a circular aperture.

Optionally the sample tracking card is labelled with an ID code. Optionally the card is labelled with a machine-readable ID code. For example, the ID code may comprise a barcode, such as a matrix barcode, for example a quick response (QR) code. A machine able to read the machine-readable ID code (for example, a scanning device built into a stand, or a hand-held scanning device) may store the ID code for uploading (either immediately, or subsequently) to a database, or may immediately transmit the ID code for uploading to a database.

Optionally the card further comprises a removable sticker for sticking to a sample collection container for attachment to the card. For example, the removable sticker may be labelled with an identification (ID) code that is identical to an ID code on the sample card, so that the sample collection container can be matched with the sample card once the container has been detached from the card, for example for testing of a biological sample in the container.

Optionally the card may comprise more than one removable sticker, for example two removable stickers, so that one sticker can be attached to the sample collection container and the other can be attached to a paper record. For example, if a test facility keeps paper records, the second sticker can be attached to that paper record to avoid risk of transcription errors in recording the ID code.

Optionally the card comprises a labelling zone for labelling the card.

Optionally the card comprises a labelling zone for labelling the card with a subject (or patient) identification code.

For example, the labelling zone may contain areas for recording on the card (for example, by hand-written recordal) details anonymously linking the subject to the card, general details about the subject, and details relating to the sample. For example, the labelling zone may include areas for recordal of any of the following details: a subject (or patient) identification code; a sample identification code; a sample collection date; general details of the subject, such as the age and/or sex of the subject.

Once the subject's ID code is recorded on the card, the sample tracking card ID code is thereby linked to the subject's ID code. This allows the subject's anonymity to be preserved, whilst ensuring that the result of any test carried out on the biological sample cannot be mixed up with the test result for any other subject. Once a test result has been obtained for the biological sample, the sample tracking card ID code associated with the sample is matched with the subject's (or patient's) ID code on the card, which can then be used to identify the subject, and inform them of the test result.

It will be appreciated that the sample tracking card (and in particular the tab and the portion of the card defining the aperture for receiving the end of the container, for example the flap) should be made of material of suitable rigidity to hold the sample collection container in place once the container is attached to the card. Optionally, the sample tracking card is made from paper, cardboard, or plastic. The sample tracking card may be of any suitable size as long as it is sufficiently large for the sample collection container to be attached to it, and to allow the necessary identification codes to be present. Examples of suitable dimensions are approximately A8 (52×74 mm), A7 (74×105 mm), A6 (105×148 mm), A5 (148×210 mm), or A4 (210×297 mm), for example 89×145 mm.

The biological sample may be any biological sample that it is desired to track using the sample tracking card, and which can be attached to the card in a sample collection container. Examples include samples of whole blood, plasma, or urine.

The sample collection container may be any suitable size for collection of a biological sample and attachment to the sample tracking card. Optionally the sample collection container is for taking a low-volume whole blood sample up to 566 μl, for example by finger prick or heel prick. The sample collection container may comprise an amount of EDTA sufficient to prevent blood clotting. A suitable sample collection container is a capillary collection microtube of MarketLab Inc, Caledonia containing a removable insert with a capillary blood collection tube (for example, a capillary collection tube 125 μl EDTA (catalogue #ML5599)).

There is also provided according to the invention a sample tracking card of the invention attached to a sample collection container.

There is further provided according to the invention a kit comprising a sample tracking card of the invention and a sample collection container for attachment to the card. The kit may further comprise any of the following additional components (for example, contained in a package, such as a resealable plastic bag); a lancet for obtaining a sample of whole blood from a subject by finger prick or heel prick; a capillary blood collection tube for directing whole blood released by the lancet into the sample collection container; an alcohol swab for sterilising an area of the subject's skin immediately prior to obtaining the whole blood sample using the lancet; one or more gloves (for example, one or more powder-free gloves) for protecting an individual collecting a sample from the subject; an isotonic solution for diluting a sample of whole blood obtained from a subject; instructions for obtaining a biological sample from a subject and/or for attaching the sample collection container to the sample tracking card.

An example of a suitable lancet for obtaining a low-volume whole blood sample is an Accu-Chek Safe-T-Pro Plus blood sampling lancet.

Embodiments of the invention are now described, by way of example only, with reference to the accompanying drawing in which;

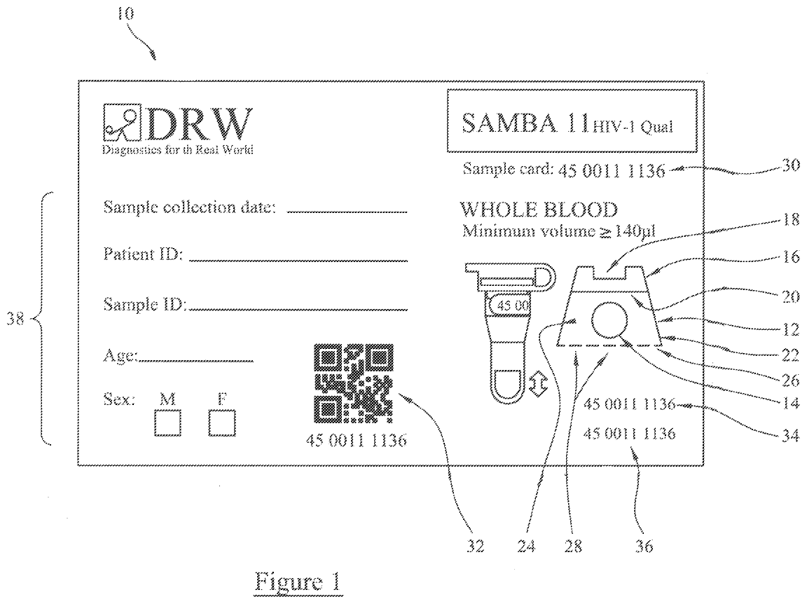

FIG. 1 shows a sample tracking card, according to an embodiment of the invention;

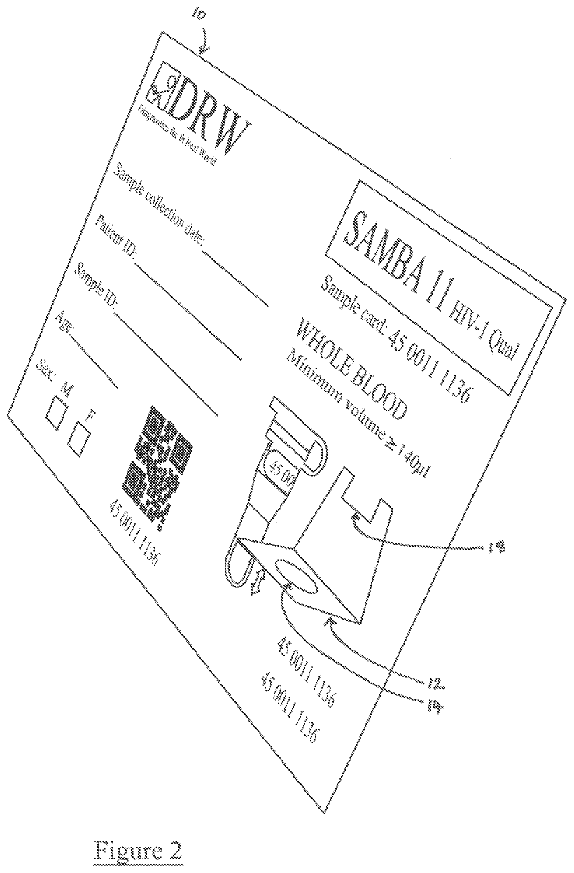

FIG. 2 shows the sample tracking card shown in FIG. 1 with its flap folded along a fold line out of the plane of the card;

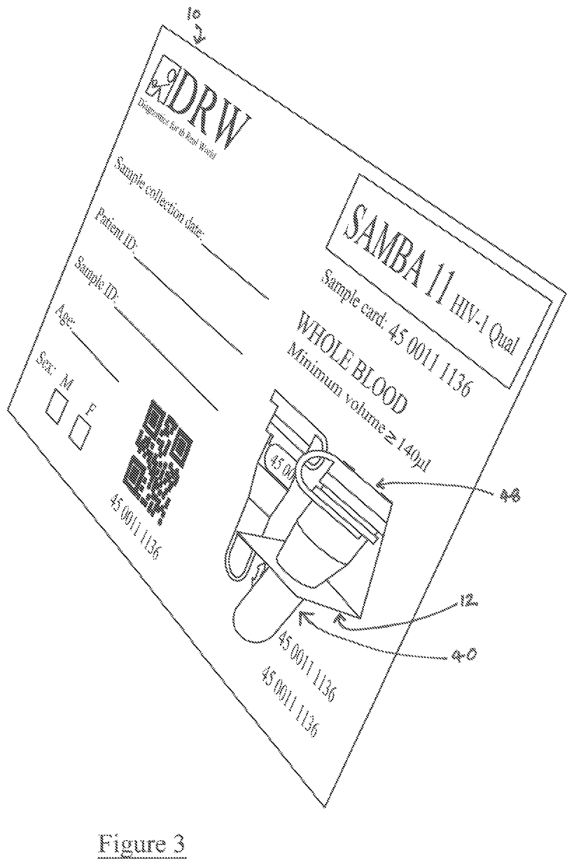

FIG. 3 shows the sample tracking card shown in FIGS. 1 and 2 with a sample collection tube attached to the card;

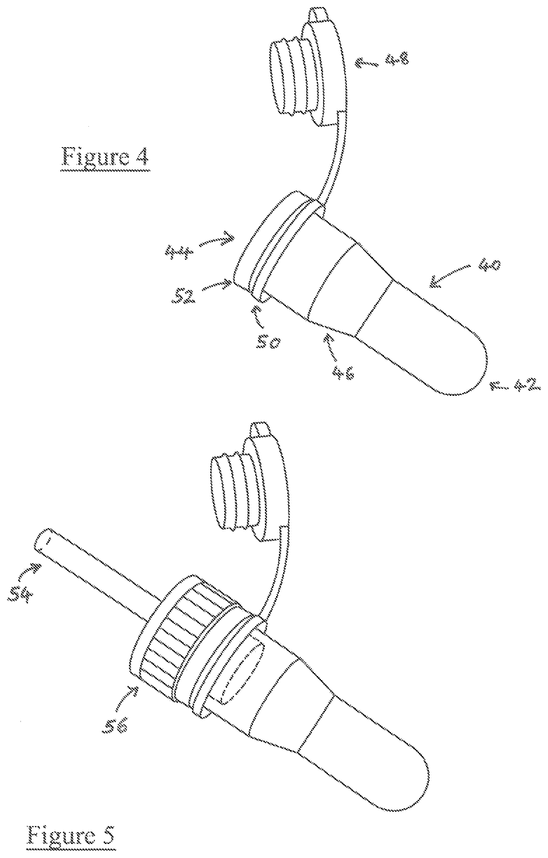

FIG. 4 shows the sample collection tube of FIG. 3; and

FIG. 5 shows the sample collection tube of FIGS. 4 and 5 with a capillary blood collection tube inserted.

Referring to FIGS. 1 and 2, a sample tracking card 10 comprises a flap 12 on the right hand side of the card, which defines an aperture 14 through the card for receiving an end of a sample collection tube. A cut-out 16 from the card defines a tab 18 for engaging with a recess in a capped end of the sample collection tube. The cut-out 16 also defines an upper edge 20 of the flap. Cuts 22, 24 through the card define side edges of the flap. The flap is hinged to the card along a fold line 26 opposite the upper edge of the flap so that the flap can be moved about the hinge out of the plane of the card. The fold line is defined by perforations 28 through the card along the fold line.

The sample tracking card 10 is labelled with an identification code 30, and a machine-readable code in the form a matrix barcode 32 (a quick response, QR, code). The card 10 also includes two removable stickers 34, 36, adjacent the flap. Each sticker is labelled with the sample tracking card identification code. A labelling zone 38 of the left hand side of the card 10 contains areas for recordal by hand of the sample collection date, subject (or patient) identification code, sample identification code, and the age and sex of the subject.

As shown in FIG. 4, a sample collection tube 40 has a narrower, closed end 42, a wider, open end 44. The tube 40 is circular in cross-section. A side wall 46 of the tube is stepped outwardly from the narrower, closed end 42 to the wider, open end 44. A push-fit cap 48 is attached to a retaining ring 50, which is retained by a collar 52 of wider diameter than an internal diameter of the retaining ring 50 at the open end 44 of the tube 40. An outer end wall of the push-fit cap 48 comprises a circular recess (not shown) for engagement by the tab 18 when the push-fit cap is pushed in place in the open end of the sample collection tube. The aperture 14 in the card is sufficiently large in diameter to receive the narrow end of the tube, but smaller in diameter than the wider end of the tube so that the tube cannot pass though the aperture.

The sample tracking card is provided in a pack with a lancet (not shown) for obtaining a whole blood sample from a subject by finger prick, an alcohol swab (not shown) for sterilising an area of the subject's finger immediately prior to obtaining the whole blood sample using the lancet, a pair of powder-free examination gloves (not shown) for use by a person collecting the blood sample, and a capillary blood collection tube for collecting the whole blood sample and directing this into the sample collection tube. The capillary blood collection tube 54 (shown in FIG. 5) is held by a friction fit through an aperture in a circular insert 56. A side wall of the insert forms a push-fit with the open end 44 of the sample collection tube 40 to retain the capillary blood collection tube in place in the sample collection tube when collecting a blood sample from a subject. Once the sample has been collected in the sample collection tube, the insert containing the capillary blood collection tube is removed from the open end of the sample collection tube, and the tube is sealed with the push-fit cap.

Before a sample has been collected, the flap 12 is in line with the card so that the card is flat for storage (as shown in FIG. 1). A person collecting a biological sample from a subject records the sample collection date, the subject's (or patient's) ID code and/or the sample ID code, and the age and sex of the subject, on the sample tracking card. A scanning device (not shown) may be used to scan the matrix barcode for uploading the code to a database.

Once a biological sample has been collected in the sample collection tube, one of the stickers is removed from the card and attached to the tube. The narrow end of the tube is then engaged with the aperture in the flap, and the upper end of the tube is moved towards the tab, causing the flap to move about its hinged edge, until the tab engages with the recess in the capped end of the tube (FIG. 2 shows the flap in a folded position out of the plane of the card). The stepping in the side wall of the tube prevents the tube from passing through the aperture in the card so that the tube is held in place by the flap and the tab (as shown in FIG. 3).

The sample tracking card and the attached sample collection tube can then be sent to a testing facility for analysis. The remaining sticker on the sample tracking card can be removed at the testing facility and attached to a paper record kept by the testing facility. This avoids any risk of transcription errors in recording the sample tracking card ID code at the testing facility. Once a test result has been obtained for the biological sample, the sample tracking card ID code associated with the sample is matched to the sample tracking card, and the subject (or patient) ID code and/or the sample ID code from the sample tracking card can be linked to the subject, who can then be informed of the test result without the tester knowing the identity of the subject.

1. A sample tracking card, which comprises an aperture for receiving an end of a sample collection container and a tab for engaging with another end of the sample collection container to attach the container to the card.

2. A card according to claim 1, wherein the aperture is defined within a hinged flap of the card.

3. A card according to claim 2, wherein the hinged flap is defined by cuts through the card.

4. A card according to claim 3, wherein the hinged flap is hinged to the card along a fold line in the card.

5. A card according to claim 4, wherein the fold line is defined by perforations through the card along the fold line.

6. A card according to any preceding claim, wherein the tab engages with a recess in a lid of the container.

7. A card according to any preceding claim, wherein the tab is defined by a cut-out from the card.

8. A card according to claim 7, wherein the cut-out also defines an edge of the hinged flap.

9. A card according to claim 8, wherein the edge of the hinged flap defined by the cut-out is opposite a hinged edge of the flap.

10. A card according to any preceding claim, wherein the container is a tube, and the aperture is a circular aperture.

11. A card according to any preceding claim, which further comprises a removable sticker for sticking to a sample collection container for attachment to the card.

12. A card according to any preceding claim, which is labelled with an identification code.

13. A card according to any preceding claim, which is labelled with a machine-readable identification code.

14. A card according to claim 13, wherein the machine-readable identification code comprises a barcode, preferably a matrix barcode, such as a quick response (QR) code.

15. A card according to any preceding claim, which comprises a zone for labelling the card with a subject (or patient) identification code.

16. A card according to any preceding claim attached to a sample collection container.

17. A kit comprising a sample tracking card according to any of claims 1 to 15, and a sample collection container for attachment to the card.

18. A kit according to claim 17, wherein the kit further comprises any of the following components: a lancet for obtaining a whole blood sample by finger prick or heel prick; an alcohol swab; a capillary blood collection tube; a glove.
